(19) United States
(12) Patent Application Publication
(10) Pub. No.: US 2011/0166938 A1
(43) Pub. Date: Jul. 7, 2011

(54) Methods For Advertising

(75) Inventors: Alexander Deridder, Houston, TX (US); Matthew Becker, Houston, TX (US); Stephen Moore, Houston, TX (US)

(73) Assignee: BIONIC CLICK LLC, Houston, TX (US)

(21) Appl. No.: 12/984,756

(22) Filed: Jan. 5, 2011

Related U.S. Application Data
(60) Provisional application No. 61/292,473, filed on Jan. 5, 2010.

(51) Int. Cl. G06Q 30/00

(52) U.S. Cl. 705/14.58

(57) ABSTRACT

A web conversion method based on phone calls is disclosed. Some embodiments comprise distributing a multiplicity of ads across a multiplicity of online media channels, displaying a unique advertiser phone number on each ad for a limited time every time a prospect visits a webpage hosting the ad, determining that the prospect called the advertiser phone number within the limited time, determining that the geographical zone of the prospect at the time of the call encompasses the geographical location of the IP address at where the unique phone number is displayed, and charging an advertiser for the ad that displayed the advertiser phone number.

### TECHNICAL FIELD

The disclosed embodiments relate to advertising, and more particularly, to advertising techniques for converting web-based or multimedia advertising to direct phone calls to the advertiser.

### BACKGROUND

The evolution of Internet advertising has been phenomenal over the past years. In earlier times, advertisers were charged a flat fee for all the advertisements that were hosted on websites irrespective of whether or not they were viewed by a prospect, i.e. a person visiting an Internet webpage or other media that includes advertising on her client device, and that person views an advertisement on that webpage or other media.

Impression-based banner advertising came in as a better method that charged advertisers by the number of impressions, or times an advertisement is displayed to, or viewed by, prospects. Although somewhat closer in spirit to pay-for-performance advertising, impression-based banner advertising is not truly pay-for-performance either since the fees to an advertiser are again in no way connected to any desired action taken by a prospect upon viewing the advertisement.

The most popular of the pay-for-performance advertising methods is the pay-per-click (PPC) advertising method. The PPC method is better in comparison to the aforesaid methods as in the PPC method, the advertisers are charged only when a prospect selects the advertisement by clicking thereon. The PPC model, unlike the earlier methods, helps in identifying and quantifying a prospect's interest in an advertisement as the prospect's click is treated as an equivalent to an interest-evinced. Also, a lot of information including the URL from where the click originated, the geographical location and the IP address of the prospect, can be generated from the one click. All this information is helpful for the advertiser in distributing the advertisements more effectively across various online media channels.

### SUMMARY

While PPC advertising provided some pay-per-performance advantages for web-based advertising over impression-based banner ads, improved correlation between actual conversion based on ads and the money spent on advertising is still needed. The deficiencies related to pay-per-performance advertising discussed above can be reduced by the disclosed methods. In some embodiments, a pay-per-performance advertising method is disclosed, wherein a phone call to the advertiser is taken as the prospect's expression of interest. Clearly, the act of a prospect contacting an advertiser via a phone is a more emphatic expression of interest than that of the prospect clicking on an advertisement (hereinafter “ad”). In some embodiments, ads are configured to display a unique advertiser phone number thereon for a limited time. The ads communicate with a remote server wherein when a prospect calls the advertiser phone number, the remote server, while routing the call to the advertiser, determines which ad enabled the prospect to reach the advertiser. The determination is based on the advertiser phone number that is called, the geographical location of the IP address where the advertisement is displayed, the time of the call, and the geographical zone from where the prospect called (determined from the prospect's phone number). The corresponding advertiser is charged a fee upon identifying the ad.

In accordance with some embodiments, a web conversion method is performed at one or more computing devices. The method includes: displaying an ad hosted by a multiplicity of webpages accessed across a plurality of geographical zones wherein, each geographical zone comprises a plurality of geographical locations, each ad in communication with a remote server; displaying, for a limited time, an advertiser phone number on each ad such that, no two ads display same advertiser phone number at one time, the advertiser phone numbers retrieved from the remote server; determining that a call is made by a prospect from a prospect phone number to an advertiser phone number within the limited time of the display of the advertiser phone number, the advertiser phone number displayed on an ad hosted by a website, the website accessed from an IP address at a geographical location; determining the geographical zone from which the call is made by the prospect; determining that the geographical location falls within the geographical zone; and charging an advertiser for the ad.

In accordance with some embodiments, at one time, no two ads viewed within one geographical zone display same advertiser phone number.

In accordance with some embodiments, the method further comprises determining that the call is held for a minimum time upon determining that the geographical location fell within the geographical zone.

In accordance with some embodiments, the method further comprises loading a conversion snippet into a hidden inline frame of the webpage upon determining that the call is held for a minimum time.

In accordance with some embodiments, the conversion snipped is loaded by a JavaScript snippet.

In accordance with some embodiments, the method further comprises displaying a default phone number in place of the advertiser phone number upon determining that the call is received to the advertiser phone number.

In accordance with some embodiments, the method further comprises displaying a default phone number in place of the advertiser phone number upon the expiry of the limited time.

In accordance with some embodiments, the method further comprises displaying, at any time, a default phone number instead of the advertiser phone number upon the unavailability of the advertiser phone numbers.

In accordance with some embodiments, the limited time display of the advertiser phone number is represented by a countdown timer displayed on the ad.

In accordance with some embodiments, the call is routed to advertiser phone number through the remote server.

In accordance with some embodiments, the call conversation is recorded in a database within the remote server.

In accordance with some embodiments, each ad is comprises a HTML tag into which an advertiser phone number is loaded from the remote server.

In accordance with some embodiments, each advertiser phone numbers is carried by a widget disposed within the remote server.

In accordance with some embodiments, JavaScript technology enables communication between the widgets and the ad.

In accordance with some embodiments, each ad is in communication with the remote server as enabled by JavaScript technology.

In accordance with some embodiments, the call is enabled by Voice-over Internet Protocol (VoIP) technology.

In accordance with some embodiments, the advertiser phone number can be reused upon the expiry of the limited time.

In accordance with some embodiments, the ad, at regular intervals, pings the remote server so as to determine that the call is made to the advertiser phone number; the pinging is terminated upon such determination.

In accordance with some embodiments, an advertiser phone number is displayed based on the webpage that is accessed, the time of access, the geographical location of the IP address from which the webpage is accessed, or any combination thereof.

In accordance with some embodiments, the geographical zone is determined from the prospect phone number.

In accordance with some embodiments, the geographical location of the IP address is obtained from a geo-targeting library.

In accordance with some embodiments, a web conversion method is performed at one or more computing devices. The method includes: displaying an ad hosted by a multiplicity of webpages accessed across a plurality of geographical zones wherein, each geographical zone comprises a plurality of geographical locations, each ad in communication with a remote server; displaying, for a limited time, an advertiser phone number on each ad such that, no two ads display same advertiser phone number at a time, the advertiser phone numbers retrieved from the remote server; determining that a call is made by a prospect from a prospect phone number to an advertiser phone number within the limited time of the display of the advertiser phone number, the advertiser phone number displayed on an ad hosted by a website, the website accessed from an IP address at a geographical location; displaying a default phone number in place of the advertiser phone number; determining the geographical zone from which the call is made by the prospect, the geographical zone is determined from the prospect phone number; determining that the geographical location falls within the geographical zone; determining that the call is held for a minimum time; loading a conversion snippet into a hidden inline frame of the webpage; and charging an advertiser for the ad.

In accordance with some embodiments, at one time, no two ads viewed within one geographical zone display same advertiser phone number.

In accordance with some embodiments, a computer-implemented method is performed at a server computer. The method includes: generating an ad that is configured to be displayed at a plurality of client devices, wherein the ad is configured to be displayed at one or more webpages that are configured to be accessed from one or more geographical zones, the ad is configured to communicate with a remote server computer when displayed at a respective client device, the ad is configured to display a first advertiser phone number when displayed at a first client device and to display a second advertiser phone number when displayed at a second client device, and the ad is configured to display the first advertiser phone number for a predefined duration after the ad is initially displayed at the first client device; and sending the ad to the first client device to be displayed.

In accordance with some embodiments, a computing device includes a display, one or more user input devices, one or more processors, memory, and one or more programs. The one or more programs are stored in the memory and configured to be executed by the one or more processors. The one or more programs include instructions for: generating an ad that is configured to be displayed at a plurality of client devices, wherein the ad is configured to be displayed at one or more webpages that are configured to be accessed from one or more geographical zones, the ad is configured to communicate with a remote server computer when displayed at a respective client device, the ad is configured to display a first advertiser phone number when displayed at a first client device and to display a second advertiser phone number when displayed at a second client device, and the ad is configured to display the first advertiser phone number for a predefined duration after the ad is initially displayed at the first client device; and sending the ad to the first client device to be displayed.

In accordance with some embodiments, a computer readable storage medium has stored therein one or more programs, the one or more programs comprising instructions, which when executed by a computing device with a display and one or more user input devices, cause the computing device to: generate an ad that is configured to be displayed at a plurality of client devices, wherein the ad is configured to be displayed at one or more webpages that are configured to be accessed from one or more geographical zones, the ad is configured to communicate with a remote server computer when displayed at a respective client device, the ad is configured to display a first advertiser phone number when displayed at a first client device and to display a second advertiser phone number when displayed at a second client device, and the ad is configured to display the first advertiser phone number for a predefined duration after the ad is initially displayed at the first client device; and send the ad to the first client device to be displayed.

In accordance with some embodiments, a computing device includes a display; one or more user input devices; and means for generating an ad that is configured to be displayed at a plurality of client devices, wherein the ad is configured to be displayed at one or more webpages that are configured to be accessed from one or more geographical zones, the ad is configured to communicate with a remote server computer when displayed at a respective client device, the ad is configured to display a first advertiser phone number when displayed at a first client device and to display a second advertiser phone number when displayed at a second client device, and the ad is configured to display the first advertiser phone number for a predefined duration after the ad is initially displayed at the first client device; and means for sending the ad to the first client device to be displayed.

In accordance with some embodiments, an information processing apparatus for use in a computing device includes a display, one or more user input devices, and means for generating an ad that is configured to be displayed at a plurality of client devices, wherein the ad is configured to be displayed at one or more webpages that are configured to be accessed from one or more geographical zones, the ad is configured to communicate with a remote server computer when displayed at a respective client device, the ad is configured to display a first advertiser phone number when displayed at a first client device and to display a second advertiser phone number when displayed at a second client device, and the ad is configured to display the first advertiser phone number for a predefined duration after the ad is initially displayed at the first client device; and means for sending the ad to the first client device to be displayed.

In accordance with some embodiments, a method is performed at a first computing device with a display and one or more user input devices. The method includes: receiving from a server computer an ad that is configured to be displayed at one or more computing devices, wherein the ad is configured to communicate with a remote server computer when displayed at the first computing device, the ad is configured to display an advertiser phone number, and the ad is configured to display the advertiser phone number for a predefined duration after the ad is initially displayed at the first computing device; and displaying the ad at the first computing device.

In accordance with some embodiments, a computing device includes a display, one or more user input devices, one or more processors, memory, and one or more programs. The one or more programs are stored in the memory and configured to be executed by the one or more processors. The one or more programs include instructions for: receiving from a server computer an ad that is configured to be displayed at one or more computing devices, wherein the ad is configured to communicate with a remote server computer when displayed at the first computing device, the ad is configured to display an advertiser phone number, and the ad is configured to display the advertiser phone number for a predefined duration after the ad is initially displayed at the first computing device; and displaying the ad at the first computing device.

In accordance with some embodiments, a computer readable storage medium has stored therein one or more programs, the one or more programs comprising instructions, which when executed by a computing device with a display and one or more user input devices, cause the computing device to: receive from a server computer an ad that is configured to be displayed at one or more computing devices, wherein the ad is configured to communicate with a remote server computer when displayed at the first computing device, the ad is configured to display an advertiser phone number, and the ad is configured to display the advertiser phone number for a predefined duration after the ad is initially displayed at the first computing device; and display the ad at the first computing device.

In accordance with some embodiments, a computing device includes a display; one or more user input devices; and means for receiving from a server computer an ad that is configured to be displayed at one or more computing devices, wherein the ad is configured to communicate with a remote server computer when displayed at the first computing device, the ad is configured to display an advertiser phone number, and the ad is configured to display the advertiser phone number for a predefined duration after the ad is initially displayed at the first computing device; and means for displaying the ad at the first computing device.

In accordance with some embodiments, an information processing apparatus for use in a computing device includes a display, one or more user input devices, and means for means for receiving from a server computer an ad that is configured to be displayed at one or more computing devices, wherein the ad is configured to communicate with a remote server computer when displayed at the first computing device, the ad is configured to display an advertiser phone number, and the ad is configured to display the advertiser phone number for a predefined duration after the ad is initially displayed at the first computing device; and means for displaying the ad at the first computing device.

In accordance with some embodiments, a default phone number is displayed after the predefined duration has elapsed.

In accordance with some embodiments, it is determined whether a prospect made a valid call to the first advertiser phone number.

In accordance with some embodiments, an advertiser is charged for the ad after determining that the prospect made the valid call to the first advertiser phone number.

In accordance with some embodiments, determining that a prospect made the valid call to the first advertiser phone number includes analyzing one or more metrics selected from the group consisting of call duration to the first advertiser phone number, an Internet Protocol address of the first client device, the respective geographical zone the first client device was physically present in when the server computer sent the ad to the first client device, and a respective geographical location the first client device was physically present in when the server computer sent the ad to the first client device.

In accordance with some embodiments, the server computer is the remote server computer.

In accordance with some embodiments, when the first client device and the second client device are physically located in the same geographic zone, the ad is configured to display an identical advertiser phone number at both the first and second client devices.

In accordance with some embodiments, at least one of the one or more geographical zones includes one or more geographic locations.

In accordance with some embodiments, when the first client device and the second client device are physically located in the same geographic location, the ad is configured to display an identical advertiser phone number at both the first and second client devices.

In accordance with some embodiments, when the first client device and the second client device are physically located in the same geographic zone, and when the first client device and the second client device are at different geographic locations within the same geographic zone, the ad is configured to display the first advertiser phone number at the first client device and the second advertiser phone number at the second client device, wherein the first and second advertiser phone numbers are distinct.

Thus, the disclosed methods present improved and more cost efficient Internet advertising methods. The disclosed methods may complement or replace other Internet advertising methods.

### BRIEF DESCRIPTION OF THE DRAWINGS

FIG. 1 illustrates the communication between the ad and the remote server via a network in accordance with some embodiments.

FIG. 2 illustrates how the data generated from the advertiser phone number and the prospect phone number are matched according to some embodiments.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

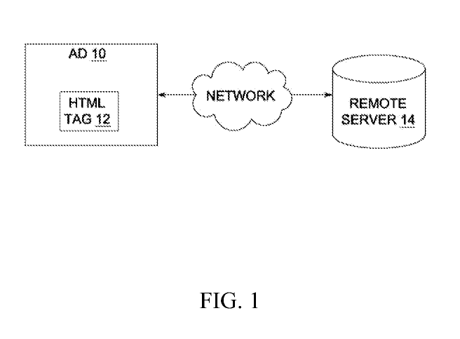

In some embodiments, a web conversion method for Internet advertising is initiated with an advertiser creating an online advertisement (hereinafter “ad”), such as a web banner, for display in media that includes ads, e.g. webpages, games on client devices such as mobile phones and personal computers, etc. In some embodiments, the ad is configured with HyperText Markup Language (hereinafter “HTML”) with embedded JavaScript elements, though those skilled in the art will recognize that any suitable technique can be used to configure an ad. Ads may be configured to display static and dynamic content, wherein the static content may comprise sales pitch, the logo of the advertiser's company, etc. Dynamic content is typically intended to persuade a prospect viewing the ad to take an immediate action. As illustrated in FIG. 1, in some embodiments, dynamic content is loaded and constantly updated. For example, dynamic content is conveyed with an HTML tag 12, which is embedded into the ad 10. In this example, the HTML tag 12 could be an HTML DIV or SPAN tag. In the case of this example, the HTML tag 12 is adapted to communicate with a remote server 14 over a network as enabled by JavaScript technology. The remote server 14 is responsible for displaying and updating the dynamic content into the HTML tag 12 in real time via the JavaScript technology.

In some embodiments, copies of the ad are generated for use by an online search engine entity, which in turn distributes the ads to one or more online media channels, e.g., webpages or other suitable media channels available to users of computers, hand-held consumer electronic devices, mobile phones, smart televisions, console gaming devices, etc. In some embodiments, the ads are configured to be accessed across a plurality of geographical zones, and typically, a geographical zone will include one or more geographical locations (though in some instances, a geographical zone will be coextensive with a geographical location). In some embodiments, a JavaScript snippet is embedded into a webpage to facilitate ad displays within the webpage. In some embodiments, a search engine tags, configures, or associates the ad with a plurality of keywords so that when a user of the search engine includes one of the keywords in a search she performs with the search engine, the ad is retrieved from a search engine server to be displayed on a webpage, along with the search results for that keyword.

In some embodiments, the remote server supplies a default phone number and a pool of reusable advertiser phone numbers wherein, each phone number is carried by a widget, or any suitable means, e.g., HTML, JavaScript containers of information, etc. In this example, the widgets are in constant communication with the HTML tag as enabled by JavaScript technology; accordingly, each ad is configured to display an advertiser phone number for a limited time, and no two ads would be configured to display the same advertiser phone number at one time. More particularly, when a prospect visits a webpage that hosts the ad, the HTML tag begins to communicate with the remote server. In some embodiments, the communication between the remote server and the ad is enabled by JavaScript technology. An advertiser phone number is consequently loaded into the HTML tag whereby, the advertiser phone number is displayed as dynamic content on the ad for a limited time. In some embodiments, a countdown timer is configured to be displayed in conjunction with the ad so as to represent a limited display time. In alternate embodiments, a countdown timer is configured to be displayed in conjunction with the ad to indicate when the advertised offer expires.

In some embodiments, after an ad is configured with an advertiser phone number, and the ad is displayed at a prospect's client device, a JavaScript snippet associated with the ad communicates with the remote server within the limited time to determine if a call is received to the advertiser phone number. In some embodiments, the ad communicates with the remote server at periodic intervals. When such a call is received at the remote server (which indicates that a prospect has called the advertiser phone number), the HTML tag is configured with a default phone number, which will then be displayed in place of the advertiser phone number. Subsequently, the JavaScript snippet stops communicating with the remote server. In some embodiments, after a limited time expires, but no call to the advertiser phone number was received, the HTML tag is configured with a default phone number. In some embodiments, the HTML tag is configured with a default phone number when there are no advertiser phone numbers available for upload.

In some embodiments, when a prospect calls the advertiser phone number displayed in an ad, the remote server records the call and generates data therefrom in order to determine which specific ad, displayed on which specific webpage, prompted the prospect's call. To determine this, the remote server, based on the advertiser phone number that is called and the time of the call received, checks the IP address from where the advertiser phone number is loaded at the time of the call, and the geographical location of the IP address. In some embodiments, the geographical location is obtained with the help of a geo-targeting library. Further, in some embodiments, the remote server determines the geographical zone of the prospect at the time of call based on the prospect's phone number. In some embodiments, the remote server is configured to use Voice-over Internet Protocol (VoIP) technology to determine which specific ad generated a prospect's call.

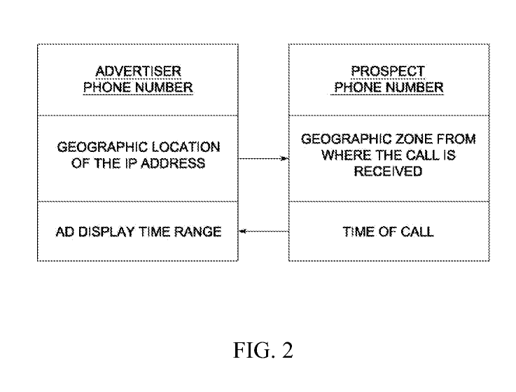

In some embodiments, after the data is evaluated to determine which specific ad accounts for the prospect's call, e.g., the time and geographic location associated with the prospect's call, the remote server, as depicted in FIG. 2, determines whether or not the determined geographical location falls within a geographical zone predefined for the ad, and whether or not the call was placed between the displayed start time and the displayed end time that the advertiser phone number was valid for the ad. In some embodiments, the duration of the prospect's call to the advertiser phone number is used as a criterion to determine whether a prospect made a valid call to the advertiser phone number.

In some embodiments, a conversion snippet is loaded by the JavaScript snippet into a hidden inline frame of the webpage. This is registered as a web conversion in the search engine server, and consequently, the advertiser is charged for the ad. In most cases, a web conversion is not registered unless one or more of the predefined criteria has been met (e.g., if the ad that displayed the advertiser phone number at the time of the call is not the one to be accounted for the call, no web conversion would be registered.) Typically, web conversions are not registered if the default phone number is called. Nevertheless, calls to the default phone number can be tracked and analyzed as well.

While the non-limiting examples of time the call was placed, geographic zone and/or location the call was placed from, and the duration of the prospect's call to the advertiser's phone number are provided as metrics to determine if there is a valid web conversion, those with skill in the art will recognize that any suitable metric can be employed to determine if there is a valid web conversion.

After a determination is made that a valid web conversion occurred, e.g., a prospect made a valid call to the advertiser phone number based on the display of the ad at the client device the prospect is using, records are generated to charge the advertiser for the web conversion, i.e., since a prospect made a valid call to the displayed advertiser's phone number, which was displayed on the ad at the prospect's client device, the advertiser will be charged for the display of the ad that prompted the prospect to place the call to the advertiser.

In some embodiments, the remote server is configured to display an advertiser phone number on more than one ad at a time, provided no two ads accessed within one geographical zone display the same advertiser phone number. For instance, an advertiser phone number is displayed on two ads at the same time, wherein the first ad can only be accessed within a first geographical zone and the second ad within a second geographical zone. If a call is received from a prospect to the advertiser phone number, the geographical zone of the prospect at the time of the call is cross-checked against the first and second geographical zones. For example, when the call from a given geographical zone is matched, e.g., the second geographical zone, it can be determined that the ad was accessed by a prospect in that given geographical zone. Accordingly, the call can be attributed to the given geographical zone, and the call from the prospect can be associated with the correct advertising client for billing purposes.

The methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A web conversion method comprising:
(a) displaying an ad hosted by a multiplicity of webpages accessed across a plurality of geographical zones wherein, each geographical zone comprises a plurality of geographical locations, each ad in communication with a remote server;
(b) displaying, for a limited time, an advertiser phone number on each ad such that, no two ads display same advertiser phone number at one time, the advertiser phone numbers retrieved from the remote server;
(c) determining that a call is made by a prospect from a prospect phone number to an advertiser phone number within the limited time of the display of the advertiser phone number, the advertiser phone number displayed on an ad hosted by a website, the website accessed from an IP address at a geographical location;
(d) determining the geographical zone from which the call is made by the prospect;
(e) determining that the geographical location falls within the geographical zone; and
(f) charging an advertiser for the ad.

2. The method of claim 1 wherein, at one time, no two ads viewed within one geographical zone display same advertiser phone number.

3. The method of claim 1 further comprising determining that the call is held for a minimum time upon determining that the geographical location fell within the geographical zone.

4. The method of claim 3 comprising loading a conversion snippet into a hidden inline frame of the webpage upon determining that the call is held for a minimum time.

5. The method of claim 4 wherein, the conversion snipped is loaded by a JavaScript snippet.

6. The method of claim 1 further comprising displaying a default phone number in place of the advertiser phone number upon determining that the call is received to the advertiser phone number.

7. The method of claim 1 further comprising displaying a default phone number in place of the advertiser phone number upon the expiry of the limited time.

8. The method of claim 1 further comprising displaying, at any time, a default phone number instead of the advertiser phone number upon the unavailability of the advertiser phone numbers.

9. The method of claim 1 wherein, the limited time display of the advertiser phone number is represented by a countdown timer displayed on the ad.

10. The method of claim 1 wherein the call is routed to advertiser phone number through the remote server.

11. The method of claim 1 wherein, the call conversation is recorded in a database within the remote server.

12. The method of claim 1 wherein, each ad is comprises a HTML tag into which an advertiser phone number is loaded from the remote server.

13. The method of claim 1 wherein, each advertiser phone numbers is carried by a widget disposed within the remote server.

14. The method of claim 13 wherein, JavaScript technology enables communication between the widgets and the ad.

15. The method of claim 1 wherein, each ad is in communication with the remote server as enabled by JavaScript technology.

16. The method of claim 1 wherein, the call is enabled by Voice-over Internet Protocol (VoIP) technology.

17. The method of claim 1 wherein, the advertiser phone number can be reused upon the expiry of the limited time.

18. The method of claim 1 wherein, the ad, at regular intervals, pings the remote server so as to determine that the call is made to the advertiser phone number; the pinging is terminated upon such determination.

19. The method of claim 1 wherein, an advertiser phone number is displayed based on the webpage that is accessed, the time of access, the geographical location of the IP address from which the webpage is accessed, or any combination thereof.

20. The method of claim 1 wherein, the geographical zone is determined from the prospect phone number.

21. The method of claim 1 wherein, the geographical location of the IP address is obtained from a geo-targeting library.

22. A web conversion method, comprising:
(a) displaying an ad hosted by a multiplicity of webpages accessed across a plurality of geographical zones wherein, each geographical zone comprises a plurality of geographical locations, each ad in communication with a remote server;
(b) displaying, for a limited time, an advertiser phone number on each ad such that, no two ads display same advertiser phone number at a time, the advertiser phone numbers retrieved from the remote server;
(c) determining that a call is made by a prospect from a prospect phone number to an advertiser phone number within the limited time of the display of the advertiser phone number, the advertiser phone number displayed on an ad hosted by a website, the website accessed from an IP address at a geographical location;
(d) displaying a default phone number in place of the advertiser phone number;
(e) determining the geographical zone from which the call is made by the prospect, the geographical zone is determined from the prospect phone number;
(f) determining that the geographical location falls within the geographical zone;
(g) determining that the call is held for a minimum time;
(h) loading a conversion snippet into a hidden inline frame of the webpage;
(i) charging an advertiser for the ad.

23. The method of claim 22 wherein, at one time, no two ads viewed within one geographical zone display same advertiser phone number.

24. A computer-implemented method, comprising:
at a server computer:
generating an ad that is configured to be displayed at a plurality of client devices, wherein:
the ad is configured to be displayed at one or more webpages that are configured to be accessed from one or more geographical zones,
the ad is configured to communicate with a remote server computer when displayed at a respective client device,
the ad is configured to display a first advertiser phone number when displayed at a first client device and to display a second advertiser phone number when displayed at a second client device, and
the ad is configured to display the first advertiser phone number for a predefined duration after the ad is initially displayed at the first client device; and
sending the ad to the first client device to be displayed.

25. The computer-implemented method of claim 24, further comprising displaying a default phone number after the predefined duration has elapsed.

26. The computer-implemented method of claim 24, further comprising determining that a prospect made a valid call to the first advertiser phone number.

27. The computer-implemented method of claim 26, further comprising charging an advertiser for the ad after determining that the prospect made the valid call to the first advertiser phone number.

28. The computer-implemented method of claim 26, wherein determining that a prospect made the valid call to the first advertiser phone number includes analyzing one or more metrics selected from the group consisting of call duration to the first advertiser phone number, an Internet Protocol address of the first client device, the respective geographical zone the first client device was physically present in when the server computer sent the ad to the first client device, and a respective geographical location the first client device was physically present in when the server computer sent the ad to the first client device.

29. The computer-implemented method of claim 24, wherein the server computer is the remote server computer.

30. The computer-implemented method of claim 24, wherein when the first client device and the second client device are physically located in the same geographic zone, the ad is configured to display an identical advertiser phone number at both the first and second client devices.

31. The computer-implemented method of claim 24, wherein at least one of the one or more geographical zones includes one or more geographic locations.

32. The computer-implemented method of claim 31, wherein when the first client device and the second client device are physically located in the same geographic location, the ad is configured to display an identical advertiser phone number at both the first and second client devices.

33. The computer-implemented method of claim 31, wherein when the first client device and the second client device are physically located in the same geographic zone, and when the first client device and the second client device are at different geographic locations within the same geographic zone, the ad is configured to display the first advertiser phone number at the first client device and the second advertiser phone number at the second client device, wherein the first and second advertiser phone numbers are distinct.

34. A computer-implemented method, comprising:
at a first computing device:
receiving from a server computer an ad that is configured to be displayed at one or more computing devices, wherein:
the ad is configured to communicate with a remote server computer when displayed at the first computing device,
the ad is configured to display an advertiser phone number, and
the ad is configured to display the advertiser phone number for a predefined duration after the ad is initially displayed at the first computing device; and
displaying the ad at the first computing device.
